(19) United States
(12) Patent Application Publication
(10) Pub. No.: US 2023/0063198 A1
(43) Pub. Date: Mar. 2, 2023

(54) CHEMICAL RESISTANT POLYCARBONATE BLEND COMPOSITIONS

(71) Applicant: Covestro LLC, Pittsburgh, PA (US)

(72) Inventors: Marina Rogunova, Pittsburgh, PA (US); Abigail M. McShane, Pittsburgh, PA (US)

(21) Appl. No.: 17/789,892

(22) PCT Filed: Dec. 21, 2020
(86) PCT No.: PCT/US2020/066383

§ 371 Date: Jun. 29, 2022

Related U.S. Application Data
(60) Provisional application No. 62/956,370, filed on Jan. 2, 2020.

(30) Foreign Application Priority Data
May 28, 2020 (EP) 20177078.1

(51) Int. Cl. C08L 69/00; C08L 53/02; C08L 83/04; C08L 33/12; C08L 33/06

(52) U.S. Cl. CPC C08L 69/005; C08L 53/02; C08L 83/04; C08L 33/12; C08L 33/068; C08L 2207/53

(57) ABSTRACT

A thermoplastic molding composition having superior impact strength and chemical resistance comprising 50 to 90 percent by weight (pbw) of an aromatic (co)poly(ester)carbonate, greater than 0 to 40 pbw of first graft (co)polymer comprising structural units derived from styrene, acrylonitrile and 1,3-butadiene, greater than 0 to 6 pbw of a linear glycidyl ester functional polymer comprising repeating units derived from one or more glycidyl ester monomers, greater than 0 to 15 pbw of a second graft (co)polymer comprising a core of (i) an interpenetrated network of poly(meth)alkyl acrylate and polyorganosiloxane or (ii) repeating units derived from a monoethylenically unsaturated acrylate monomer or, and a rigid phase shell selected from the group consisting of methyl methacrylate, ethyl methacrylate, propyl methacrylate, isopropyl methacrylate and butyl methacrylate, styrene and acrylonitrile, and 0.1-1.5 pbw of an alkylbenzene sulfonic acid.

### FIELD OF THE INVENTION

The invention is directed to a thermoplastic molding composition comprising polycarbonate, and demonstrating a high strength and chemical resistance.

### TECHNICAL BACKGROUND OF THE INVENTION

Commercial blends of polycarbonate and other copolymers offer good stiffness, tensile and flexural strength and high impact resistance for a variety of applications when molded. However, many such blends are resistant to weak acids, aliphatic hydrocarbons, some alcohols, oils and greases. One of the drawbacks of such blends is a limited chemical resistance to alkali, oxidizing acids, amines and ketones. The copolymers may be attacked by oxidizing strong acids, bases, ammonia, methanol, aromatic and chlorinated hydrocarbons. In addition, blends can be very sensitive to hydrolysis, and may crack with long term exposure to moisture as well as other contributing factors such as elevated temperatures.

Products that are molded from polycarbonate blend compositions may be exposed to a variety of chemicals that may harm their expected performance. Thus, there is a need for a new polycarbonate molding composition that can be resistant to such chemicals while maintaining excellent strength and surface quality.

### SUMMARY OF THE INVENTION

In an embodiment, a thermoplastic molding composition comprises (A) 50 to 90 percent by weight relative to the weight of the composition (pbw) of an aromatic (co)poly(ester)carbonate, (B) greater than 0 to 40 pbw of first graft (co)polymer comprising structural units derived from styrene, acrylonitrile and 1,3-butadiene, (C) greater than 0 to 6 pbw of a linear glycidyl ester functional polymer comprising repeating units derived from one or more glycidyl ester monomers, (D) greater than 0 to 15 pbw of a second graft (co)polymer comprising a core and shell wherein the molecular structure of the core comprises (i) an interpenetrated network of poly(meth)alkyl acrylate and polyorganosiloxane or (ii) repeating units derived from a monoethylenically unsaturated acrylate monomer, and wherein the shell is a rigid phase comprising repeating units derived from a monoethylenically unsaturated monomer selected from the group consisting of methyl methacrylate, ethyl methacrylate, propyl methacrylate, isopropyl methacrylate and butyl methacrylate, styrene and acrylonitrile, and (E) 0.1-1.5 pbw of an alkylbenzene sulfonic acid.

In another embodiment, the aromatic (co)poly(ester)carbonate is present in the composition in an amount of 58-72 pbw, preferably 62-68 pbw, most preferably 63 -66 pbw. In yet another, Component B further comprises structural units derived from at least one alkyl (meth)acrylate, and may in another embodiment comprise (i) a disperse phase comprising rubber particles and (ii) a rubber-free vinyl copolymer matrix not bound to the rubber particles and not incorporated into the rubber particles. In another embodiment related to the previous one, the disperse phase consists of (i1) rubber particles grafted with vinyl copolymer composed of structural units derived from styrene, acrylonitrile and optionally at least one alkyl (meth)acrylate; and (i.2) vinyl copolymer incorporated in the rubber particles as a separate disperse phase, likewise composed of structural units derived from styrene, acrylonitrile and optionally at least one alkyl (meth)acrylate. In a different embodiment, the disperse phase (i) has a median diameter D₅₀ measured by ultracentrifugation of 0.3 to 2.0 μm, further preferably of 0.5 to 1.5 μm, especially of 0.7 to 1.2 μm.

In yet another embodiment, the first graft (co)polymer is a product of mass suspension polymerization. In still another, the first graft (co)polymer is free of alkali metal, alkaline earth metal, ammonium or phosphonium salts of saturated fatty acids having 8 to 22 carbon atoms, resin acids, alkyl- and alkylarylsulfonic acids and fatty alcohol sulfates. In a different embodiment, the first graft (co)polymer is free of at least one of all salts, all surfactants and all emulsifiers, preferably free of all salts, surfactants and emulsifiers. In still another embodiment, the first graft (co)polymer contains less than 100 ppm, preferably less than 50 ppm, more preferably less than 20 ppm, of ions of alkali metals and alkaline earth metals. The first grant (co)polymer may be present in the composition in an amount of 5-35 pbw, preferably 10-30 pbw, most preferably 17 - 26 pbw.

In another embodiment not yet disclosed, the linear glycidyl ester is a terpolymer selected from the group consisting of ethylene/ alkylacrylate/glycidyl methacrylate; ethylene/alkyl acrylate/glycidyl acrylate; ethylene/alkyl methacrylate/glycidyl acrylate; and ethylene/alkyl methacrylate/glycidyl methacrylate. In another, the linear glycidyl ester functional polymer is present in the composition in an amount of 1-4 pbw, preferably 2-3 pbw. The molecular structure of the core of the second graft (co)polymer may comprise an interpenetrated network of polybutyl acrylate and polysiloxane. In another embodiment, the molecular structure of the core of the second graft (co)polymer comprises butyl acrylate. In still another, the shell is a rigid phase comprising repeating units derived from methyl methacrylate, or from methyl methacrylate and styrene. The second graft (co)polymer may be present in the composition in an amount of from 1-12 pbw, preferably 2-6 pbw. In addition, the ratio of the wt. of Component D to the wt. of Component C in the thermoplastic composition, may range from 1.5:1 to 3:1, preferably from 1.7:1 to 2.4:1.

In a different embodiment, the alkylbenzene sulfonic acid comprises a C6 - C20 long chain monoalkene, and may be selected from the group consisting of octylbenzene sulfonic acid, nonylbenzene sulfonic acid, decylbenzene sulfonic acid, undecylbenzene sulfonic acid and dodecylbenzene sulfonic acid, preferably from the group consisting of octylbenzene sulfonic acid, decylbenzene sulfonic acid and dodecylbenzene sulfonic acid. In another embodiment, the alkylbenzene sulfonic acid is present in the composition in an amount of 0.3-1.1 pbw.

In yet another embodiment, the composition further comprises (F) a vinyl (co)polymer comprising a vinyl compound selected from the group consisting of styrene, α-methylstyrene, p-methylstyrene, p-chlorostyrene, and (meth)acrylic acid (C1-C8)-alkyl esters. In an embodiment, the vinyl (co)polymer is styrene acrylonitrile. The vinyl (co)polymer may be present in the composition in an amount of greater than 0 to 15 pbw, preferably greater than 0 to 8 pbw.

In still another embodiment, the composition may further comprise at least one member selected from the group consisting of lubricant, mold release agents, nucleating agent, antistatic agent, thermal stabilizer, light stabilizer, hydrolytic stabilizer, filler, reinforcing agent, colorant, pigment, flame retarding agent and drip suppressant.

### DETAILED DESCRIPTION OF THE INVENTION

The inventive thermoplastic composition comprises
(A) 50 to 90 pbw, preferably 58 to 72 pbw, more preferably 62-68 pbw, even more preferably 62-68 percent by weight relative to the weight of the composition (pbw) of an aromatic (co)poly(ester)-carbonate,
(B) greater than 0 to 40, preferably 5 to 35 pbw, more preferably 10 to 30, even more preferably 17 to 26 pbw of first graft (co)polymer comprising structural units derived from styrene, acrylonitrile and 1,3-butadiene,
(C) greater than 0 to 6 pbw, preferably 1 to 5 pbw, more preferably 2 to 3 pbw of a linear glycidyl ester functional polymer comprising repeating units derived from one or more glycidyl ester monomers,
(D) greater than 0 to 15, preferably 1 to 12 pbw, more preferably 2 to 6 pbw of a second graft (co)polymer comprising a core and shell wherein the molecular structure of the core comprises (i) an interpenetrated network of poly(meth)alkyl acrylate and polyorganosiloxane or (ii) repeating units derived from a monoethylenically unsaturated acrylate monomer, and wherein the shell is a rigid phase comprising repeating units derived from a monoethylenically unsaturated monomer selected from the group consisting of methyl methacrylate, ethyl methacrylate, propyl methacrylate, isopropyl methacrylate and butyl methacrylate, styrene and acrylonitrile, and
(E) 0.1 to 1.5 pbw, preferably 0.3 to 1.1 pbw, of an alkylbenzene sulfonic acid.

### (A) Aromatic (Co)poly(ester)carbonate

The term aromatic (co)poly(ester)carbonates, refers to homopolycarbonates, copolycarbonates, including polyestercarbonates. These materials are well known and are available in commerce.

(Co)poly(ester)carbonates may be prepared by known processes including melt transesterification process and interfacial polycondensation process (see for instance Schnell's “Chemistry and Physics of Polycarbonates”, Interscience Publishers, 1964) and are widely available in commerce, for instance under the trademark Makrolon® from Covestro LLC, Pittsburgh, Pa.

Aromatic dihydroxy compounds suitable for the preparation of aromatic (co)poly(ester)carbonates (herein referred to as polycarbonates) conform to formula (I)

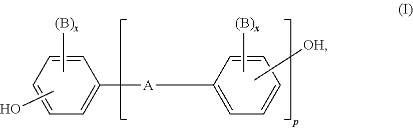

wherein
A represents a single bond, C₁- to C₅-alkylene, C₂- to C₅-alkylidene, C₅- to C₆-cycloalkylidene, —O—, —SO—, —CO—, —S—, —SO₂—, C₆- to C₁₂-arylene, to which there may be condensed other aromatic rings optionally containing hetero atoms, or a radical conforming to formula (II) or (Ill)

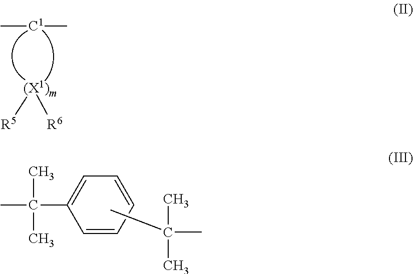

The substituents B independently one of the others denote C₁- to C₁₂-alkyl, preferably methyl, x independently one of the others denote 0, 1 or 2, p represents 1 or 0, and R⁵ and R⁶ are selected individually for each X¹ and each independently of the other denote hydrogen or C₁- to C₆-alkyl, preferably hydrogen, methyl or ethyl, X¹ represents carbon, and m represents an integer of 4 to 7, preferably 4 or 5, with the proviso that on at least one atom X¹, R⁵ and R⁶ are both alkyl groups.

Preferred aromatic dihydroxy compounds are hydroquinone, resorcinol, dihydroxydiphenols, bis-(hydroxyphenyl)-C₁-C₅-alkanes, bis-(hydroxyphenyl)-C₅-C₆-cycloalkanes, bis-(hydroxyphenyl) ethers, bis-(hydroxyphenyl) sulfoxides, bis-(hydroxyphenyl) ketones, bis-(hydroxyphenyl)-sulfones and α,α-bis-(hydroxyphenyl)-diisopropylbenzenes. Particularly preferred aromatic dihydroxy compounds are 4,4′-dihydroxydiphenyl, bisphenol A, 2,4-bis-(4-hydroxyphenyl)-2-methylbutane, 1,1-bis-(4-hydroxyphenyl)-cyclohexane, 1,1-bis-(4-hydroxyphenyl)-3,3,5-trimethylcyclohexane, 4,4′-dihydroxydiphenyl sulfide, 4,4′-dihydroxydiphenyl-sulfone. Special preference is given to 2,2-bis-(4-hydroxyphenyl)-propane (bisphenol A). These compounds may be used singly or as mixtures containing two or more aromatic dihydroxy compounds.

Chain terminators suitable for the preparation of polycarbonates include phenol, p-chlorophenol, p-tert.-butylphenol, as well as long-chained alkylphenols, such as 4-(1,3-tetramethylbutyl)-phenol or monoalkylphenols or dialkylphenols having a total of from 8 to 20 carbon atoms in the alkyl substituents, such as 3,5-di-tert.-butylphenol, p-isooctylphenol, p-tert.-octylphenol, p-dodecylphenol and 2-(3,5-dimethylheptyl)-phenol and 4-(3,5-dimethylheptyl)-phenol. The amount of chain terminators to be used is generally 0.5 to 10% based on the total molar amount of the aromatic dihydroxy compounds used.

Polycarbonates may be branched in a known manner, preferably by the incorporation of 0.05 to 2.0%, based on the molar amount of the aromatic dihydroxy compounds used, of compounds having a functionality of three or more, for example compounds having three or more phenolic groups.

Aromatic polyestercarbonates are known. Suitable such resins are disclosed in U.S. Patents 4,334,053: 6,566,428 and in CA1173998, all incorporated herein by reference.

Aromatic dicarboxylic acid dihalides for the preparation of aromatic polyester carbonates include diacid dichlorides of isophthalic acid, terephthalic acid, diphenyl ether 4,4′-dicarboxylic acid and naphthalene-2,6-dicarboxylic acid. Particularly preferred are mixtures of diacid dichlorides of isophthalic acid and terephthalic acid in a ratio of from 1:20 to 20:1. Branching agents may also be used in the preparation of suitable polyestercarbonates, for example, carboxylic acid chlorides having a functionality of three or more, such as trimesic acid trichloride, cyanuric acid trichloride, 3,3′-,4,4′-benzophenone-tetracarboxylic acid tetrachloride, 1,4,5,8-naphthalenetetracarboxylic acid tetrachloride or pyromellitic acid tetrachloride, in amounts of 0.01 to 1.0 mol. % (based on dicarboxylic acid dichlorides used), or phenols having a functionality of three or more, such as phloroglucinol, 4,6-dimethyl-2,4,6-tri-(4-hydroxyphenyl)-heptene-2, 4,4-dimethyl-2,4,6-tri-(4-hydroxyphenyl)-heptane, 1,3,5-tri-(4-hydroxyphenyl)-benzene, 1,1,1-tri-(4-hydroxyphenyl)-ethane, tri-(4-hydroxyphenyl)-phenylmethane, 2,2-bis[4,4-bis(4-hydroxyphenyl)-cyclohexyl]-propane, 2,4-bis(4-hydroxyphenyl-isopropyl)-phenol, tetra-(4-hydroxyphenyl)-methane, 2,6-bis(2-hydroxy-5-methyl-benzyl)-4-methylphenol, 2-(4-hydroxyphenyl)-2-(2,4-dihydroxyphenyl)-propane, tetra-(4-[4-hydroxyphenyl-isopro-pyl]-phenoxy)-methane, 1,4-bis[4,4′-dihydroxy-triphenyl)-methyl]-benzene, in amounts of from 0.01 to 1.0 mol. %, based on diphenols used. Phenolic branching agents can be placed in the reaction vessel with the diphenols, acid chloride branching agents may be introduced together with the acid dichlorides.

The content of carbonate structural units in the thermoplastic aromatic polyester carbonates may be up to 99 mol. %, especially up to 80 mol. %, particularly preferably up to 50 mol. %, based on the sum of ester groups and carbonate groups. Both the esters and the carbonates contained in the aromatic polyester carbonates may be present in the polycondensation product in the form of blocks or in a randomly distributed manner.

The preferred thermoplastic aromatic polycarbonates have weight-average molecular weights (measured by gel permeation chromatography (GPC), based on polystyrene standards using a Universal Calibration Method with Mark-Houwink parameters for polycarbonate and polystyrene and then reporting polycarbonate numbers. A Waters Alliance Gel Permeation Chromatograph is used to perform the separation. The data analysis is done using EmpowerPro3 software. The chromatographic conditions are: temperature: 35° C. in columns & detector; solvent is tetrahydrofuran (THF); flow rate is 1.0 ml/min.; flow standard is toluene; injection volume is 75 μl; operating pressure is 760 psi (52.4 Bar); sample concentration is 0.5%) of at least 25,000, more preferably at least 26,000. Preferably these have maximum weight-average molecular weight of 80,000, more preferably up to 70,000, particularly preferably up to 50,000 g/mol.

Component A may be present in the thermoplastic composition in an amount of 50 to 90 wt. %, preferably 58 to 72 wt. %, more preferably 62 to 68 wt. %, most preferably 63 to 66 wt. % of the thermoplastic composition.

### (B) First Graft (Co)polymer

Component B may comprise rubber-modified graft copolymers prepared by polymerization, preferably by the bulk polymerization method, of B.1 and B.2 in the proportions by weight stated below.

These rubber-modified graft copolymers are formed from

B.1) 80% to 95% by weight, preferably 85% to 93% by weight, further preferably 88% to 92% by weight, based on the rubber-modified vinyl copolymer B, of structural units derived from
B.1.1) 60% to 90% by weight, preferably 65% to 85% by weight, more preferably 67% to 80% by weight, based on component B.1, of styrene,
B.1.2) 10% to 40% by weight, preferably 15% to 35% by weight, more preferably 20% to 30% by weight, based on component B.1, of acrylonitrile,
B.1.3) optionally 0.5% to 15% by weight, preferably 2% to 8% by weight, more preferably 3% to 6% by weight, based on component
B.1, of at least one alkyl (meth)acrylate, and B.2) 5% to 20% by weight, preferably 7% to 15% by weight, further preferably 8% to 12% by weight, based on the rubber-modified vinyl copolymer B, of one or more elastomeric graft bases having glass transition temperatures T_{g}<−50° C., preferably of <−60° C., more preferably <−70° C., comprising at least 50% by weight, preferably at least 75% by weight, more preferably 100% by weight, based on B.2, of structural units derived from 1,3-butadiene,
wherein the rubber-modified vinyl copolymer B comprises
(i) a disperse phase consisting of (i1) rubber particles grafted with vinyl copolymer composed of structural units B.1 and (i.2) vinyl copolymer incorporated in the rubber particles as a separate disperse phase, likewise composed of structural units B.1, and and
(ii) a rubber-free vinyl copolymer matrix not bound to the rubber particles and not incorporated into these rubber particles, consisting of structural units B.1.

The disperse phase (i) preferably has a median diameter D₅₀ measured by ultracentrifugation of 0.3 to 2.0 μm, further preferably of 0.5 to 1.5 μm, especially of 0.7 to 1.2 μm.

Unless expressly stated otherwise in the present invention, the glass transition temperature T_{g} is determined for all components by dynamic differential scanning calorimetry (DSC) to DIN EN 61006 (1994 version) at a heating rate of 10 K/min with determination of Tg as the midpoint temperature (tangent method).

The rubber-modified graft copolymers of component B have a melt volume flow rate (MFR), measured to ISO 1133 (2012 version) at 220° C. with a ram load of 10 kg, of preferably 2 to 60 g/10 min, more preferably 3 to 50 g/10 min and especially 4 to 40 g/10 min. If mixtures of multiple rubber-modified vinyl copolymers are used as component B, the preferred MFR ranges apply to the average of the MFR of the individual components in component B weighted by the proportions by mass of the components in the mixture.

The bulk polymerization method employed with preference for production of the rubber-modified graft copolymer B comprises both the polymerization of the vinyl monomers B.1 and grafting of the vinyl copolymer thus formed onto the rubber-elastic graft base B.2. In addition, in this reaction regime, self-organization (phase separation) forms a disperse phase (i) consisting of
(i.1) rubber particles grafted with vinyl copolymer composed of structural units B.1 and
(i.2) vinyl copolymer incorporated in the rubber particles as a separate disperse phase, likewise composed of structural units B.1,
   where this rubber-containing disperse phase (i) is dispersed in a rubber-free vinyl copolymer matrix (ii) not bound to the rubber particles and not incorporated into these rubber particles, consisting of structural units B.1.

The rubber-free vinyl copolymer (ii), by contrast with the other vinyl copolymer fractions in component B, can be leached out by means of suitable solvents, for example acetone.

The size of the disperse phase (i) in the rubber-modified vinyl copolymers B thus prepared is adjusted via the conditions of the reaction regime, such as the temperature and resulting viscosity of the polymer and shear as a result of stirring, for example.

The median particle size d5o is the diameter with 50% by weight of the particles above it and 50% by weight below it. Unless expressly stated otherwise in the present invention, it is determined for all components by means of ultracentrifuge measurement (W. Scholtan, H. Lange, Kolloid-Z. und Z. Polymere 250 (1972), 782-796).

Optional monomer B.1.3 is an alkyl (meth)acrylate, preferably a (C₁-C₈)-alkyl (meth)acrylate. Further-preferred monomers B.1.3 are methyl methacrylate, ethyl methacrylate, n-butyl acrylate and tert-butyl acrylate. Most preferably, B.1.3 is n-butyl acrylate.

Preferred graft bases B.2 are diene rubbers containing butadiene, or mixtures of diene rubbers containing butadiene or copolymers of diene rubbers containing butadiene or mixtures thereof with further copolymerizable monomers (for example according to B.1).

A particularly preferred graft base B.2 is pure polybutadiene rubber. In a further preferred embodiment, B.2 is styrene-butadiene block copolymer rubber.

Component B preferably has a polybutadiene content of 5% to 18% by weight, further preferably of 7% to 14% by weight, especially of 8% to 12% by weight.

Particularly preferred rubber-modified graft copolymers of component B are bulk ABS polymers as described, for example, in U.S. Pat. No. 3,644,574 or in GB 1,409,275.

The vinyl copolymer (ii) not chemically bonded to the rubber base(s) B.2 and not incorporated in the rubber particles may, as explained above, arise as a result of the preparation in the polymerization of the graft copolymers B. It is likewise possible that a portion of this vinyl copolymer (ii) of the rubber-modified graft copolymer component B not chemically bonded to the rubber base(s) B.2 and not incorporated in the rubber particles arises as a result of the preparation in the preparation thereof and another portion is polymerized separately and added to component B as a constituent of component B. The proportion x(ii) of the vinyl (co)polymer (ii), irrespective of its origin, measured as the acetone-soluble fraction, in component B, based on component B, is preferably at least 60% by weight, more preferably at least 70% by weight, further preferably at least 75% by weight. The proportion x(ii) of the vinyl copolymer (ii), irrespective of its origin, measured as the acetone-soluble fraction, in component B, based on component B, is preferably not more than 95% by weight, more preferably not more than 90% by weight, further preferably not more than 85% by weight.

This vinyl copolymer (ii) in the rubber-modified graft copolymers of component B preferably has a weight-average molecular weight Mw(ii) of 110 to 200 kg/mol.

In the context of the present invention, the weight average molecular weight M_{w}(ii) of the vinyl copolymer in component B is measured by gel permeation chromatography (GPC) in tetrahydrofuran against polystyrene as standard.

Component B is preferably free of alkali metal, alkaline earth metal, ammonium or phosphonium salts of saturated fatty acids having 8 to 22 carbon atoms, resin acids, alkyl- and alkylarylsulfonic acids and fatty alcohol sulfates. In other embodiments, Component B is free of at least one of all salts, all surfactants and all emulsifiers. In another embodiment, Component B is free of all salts, surfactants and emulsifiers. In yet another embodiment, Component B contains less than 100 ppm, preferably less than 50 ppm, more preferably less than 20 ppm, of ions of alkali metals and alkaline earth metals.

A preferred embodiment entails ABS (acrylonitrile-butadiene-styrene) resin preferably prepared by mass suspension polymerization (“mass ABS”). Mass ABS is characterized by its high impact strength and superior thermal ageing performance. In general, mass ABS is produced using bulk, solution, or suspension processes. In this process, the monomer/rubber matrix is polymerized in the presence of a compatible organic solvent or in bulk such that the monomer becomes a solvent. Upon continuous polymerization, the growing polymer chains become grafted onto the discontinuous rubber phase. The size of the rubber particles can be adjusted through proper agitation (shear) and by controlling the viscosity between the styrene±acrylonitrile phase and the rubber phase. When polymerization is complete, the polymer is recovered by flash separation of the monomer and/or solvent. The resulting polymer is considered to be very pure, typically having only very minor amounts of residual monomer.

Mass-produced ABS is preferred over an emulsion-produced ABS for making PC/ABS blends. This is primarily because of the chemical purity of a mass ABS resin, which results in very good thermal stability and color. In contrast, ABS resins produced from an emulsion process have more residual additives and processing aids. In the emulsion process, polymerization occurs in water solution, requiring the use of surfactant to stabilize the organic phase and buffers to control the pH. These additives have a strong negative effect on the thermal stability of the PC phase.

The composition may also comprise as component B a rubber-modified graft copolymer prepared by emulsion polymerization or a mixture of such rubber-modified graft copolymers.
Rubber-modified graft copolymers B prepared by emulsion polymerization comprise
B.1 from 5 to 95 wt. %, preferably from 15 to 92 wt. %, in particular from 25 to 60 wt. %, based on component B, of at least one vinyl monomer on
B.2 from 95 to 5 wt. %, preferably from 85 to 8 wt. %, in particular from 75 to 40 wt. %, based on component B, of at least one elastomeric graft substrate, preferably having glass transition temperatures <10° C., more preferably <0° C., particularly preferably <−20° C.
The glass transition temperature T_{g} is determined by means of differential scanning calorimetry (DSC) according to standard DIN EN 61006 at a heating rate of 10 K/min. with definition of the T_{g} as the mid-point temperature (tangent method).
The elastomeric graft base is also referred to as rubber core or as graft substrate.
The graft base B.2 generally has a mean particle size (d5o value) of from 0.05 to 10 m, preferably from 0.1 to 5 m, particularly preferably from 0.2 to 1 m.
The mean particle size d5o is the diameter above and below which in each case 50 wt. % of the particles lie. It can be determined by ultracentrifuge measurement (W. Scholtan, H. Lange, Kolloid, Z. und Z. Polymere 250 (1972), 782-1796).
Monomers B.1 are preferably mixtures of
B.1.1 from 50 to 99 parts by weight, preferably from 60 to 80 parts by weight, in particular from 70 to 80 parts by weight, based on B.1, of vinyl aromatic compounds and/or vinyl aromatic compounds substituted on the ring (such as styrene, α-methylstyrene, p-methylstyrene, p-chlorostyrene) and/or methacrylic acid (C₁-C)-alkyl esters, such as methyl methacrylate, ethyl methacrylate, and
B.1.2 from 1 to 50 parts by weight, preferably from 20 to 40 parts by weight, in particular from 20 to 30 parts by weight, based on B.1, of vinyl cyanides (unsaturated nitriles such as acrylonitrile and methacrylonitrile) and/or (meth)acrylic acid (C₁-C)-alkyl esters, such as methyl methacrylate, n-butyl acrylate, tert-butyl acrylate, and/or derivatives (such as anhydrides and imides) of unsaturated carboxylic acids, for example maleic anhydride and N-phenyl-maleimide.
Preferred monomers B.1.1 are selected from at least one of the monomers styrene, a-methylstyrene and methyl methacrylate, and preferred monomers B.1.2 are selected from at least one of the monomers acrylonitrile, maleic anhydride and methyl methacrylate. Particularly preferred monomers are B.1.1 styrene and B.1.2 acrylonitrile or B.1.1=C.1.2 methylmethacrylate.
Graft substrates B.2 suitable for the graft copolymers B are, for example, diene rubbers, diene-vinyl block copolymer rubbers, EP(D)M rubbers, i.e. those based on ethylene/propylene and optionally diene, acrylate rubbers, polyurethane rubbers, silicone rubbers, chloroprene rubbers and ethylene/vinyl acetate rubbers, and also mixtures of such rubbers or silicone-acrylate composite rubbers in which the silicone and acrylate components are chemically joined to one another (for example by grafting).
Preferred graft substrates B.2 are diene rubbers (for example based on butadiene or isoprene), diene-vinyl block copolymer rubbers (for example based on butadiene and styrene blocks), copolymers of diene rubbers with further copolymerizable monomers (for example according to B1.1 and B1.2) and mixtures of the abovementioned rubber types. Particular preference is given to pure polybutadiene rubber and styrene-butadiene block copolymer rubber.
Pure polybutadiene rubber and styrene-butadiene-block copolymers rubber are particularly preferred as the graft substrate B.2.
Particularly preferred polymers B are, for example, ABS or MBS polymers, as are described, for example, in DE-OS 2 035 390 (=US-PS 3 644 574) or in DE-OS 2 248 242 (=GB-PS 1 409 275) or in Ullmanns, Enzyklopsdie der Technischen Chemie, Vol. 19 (1980), p. 280 ff.
The gel content of the graft base B.2 is at least 30 wt. %, preferably at least 40 wt. %, in particular at least 60 wt. %, in each case based on B.2 and measured as the insoluble portion in toluene.
The gel content of the graft base B.2 is determined at 25° C. in a suitable solvent as the portion insoluble in those solvents (M. Hoffmann, H. Kromer, R. Kuhn, Polymeranalytik I und II, Georg Thieme-Verlag, Stuttgart 1977).
Particularly suitable graft bases are also ABS polymers, which are prepared by redox initiation with an initiator system of organic hydroperoxide and ascorbic acid according to US-P 4 937 285.
Because, as is known, the graft monomers are not necessarily grafted completely onto the graft base in the graft reaction, graft polymers B are also understood according to the invention as being products that are obtained by (co)polymerisation of the graft monomers in the presence of the graft base and are obtained concomitantly on working up. Such products can accordingly also contain free (co)polymer of the graft monomers, that is to say (co)polymer that is not chemically bonded to the rubber.
Suitable acrylate rubbers according to B.2 are preferably polymers of acrylic acid alkyl esters, optionally with up to 40 wt. %, based on B.2, of other polymerisable, ethylenically unsaturated monomers. The preferred polymerisable acrylic acid esters include Ci- to C₈-alkyl esters, for example methyl, ethyl, butyl, n-octyl and 2-ethylhexyl ester, haloalkyl esters, preferably halo-Cl-Ca-alkyl esters, such as chloroethyl acrylate, as well as mixtures of those monomers.

Further suitable graft bases according to B.2 are silicone rubbers having graft-active sites, as are described in DE-OS 3 704 657, DE-OS 3 704 655, DE-OS 3 631 540 and DE-OS 3 631 539.

Component B may be present in the thermoplastic composition in an amount of greater than 0 to 40 wt. %, preferably 5 to 35 wt. %, more preferably 10 to 30 wt. %, most preferably 17 to 26 wt. % of the thermoplastic composition.

### (C) Linear Glycidyl Ester

Component (C) is a linear glycidyl ester functional polymer comprising repeating units derived from one or more glycidyl ester monomers. The glycidyl ester polymer may be a polymer, copolymer, or terpolymer. A glycidyl ester monomer means a glycidyl ester of a,P-unsaturated carboxylic acid such as, e.g., acrylic acid, methacrylic acid, itaconic acid, and includes, e.g., glycidyl acrylate, glycidyl methacrylate, glycidyl itaconate. Suitable glycidyl ester polymers useful in the present invention include the glycidyl esters impact modifiers described in U.S. Pat. No. 5,981,661, incorporated herein by reference. Preferably, the glycidyl ester polymer comprises at least one repeating unit polymerized from glycidyl ester monomer and at least one repeating unit polymerized from a-olefin monomers, e.g., ethylene, propylene, 1-butene, 1-pentene. Preferably, the glycidyl ester monomer is glycidyl acrylate or glycidyl methacrylate.

Suitable linear glycidyl ester functional polymers optionally contain a minor amount, i.e., up to about 50 wt %, of repeating units derived from one or more other monoethylenically unsaturated monomers that are copolymerizable with the glycidyl ester monomer. As used herein the terminology “monoethylenically unsaturated” means having a single site of ethylenic unsaturation per molecule. Suitable copolymerizable monoethylenically unsaturated monomers include, e.g., vinyl aromatic monomers such as, e.g., styrene and vinyl toluene, vinyl esters such as e.g., vinyl acetate and vinyl propionate, and C₁-20-alkyl (meth)acrylates such as, e.g., butyl acrylate, methyl methacrylate, cyclohexyl methacrylate. As used herein, the term C₁-20 -alkyl means a straight or branched alkyl group of from 1 to 20 carbon atoms per group, such as e.g., methyl, ethyl, cyclohexyl and the term “(meth)acrylate” refers to acrylate compounds and to methacrylate compounds.

Suitable glycidyl ester copolymers may be made by conventional free radical initiated copolymerization.

More preferably, the glycidyl ester polymers useful in the present invention are selected from olefin-glycidyl (meth)acrylate polymers, olefin-vinyl acetate-glycidyl (meth)acrylate polymers and olefin-glycidyl (meth)acrylate-alkyl (meth)acrylate polymers. Most preferably, the glycidyl ester polymer is selected from random ethylene/acrylic ester/glycidyl methacrylates copolymers or terpolymers.

In the preferred embodiment, component (C) of the inventive composition contains structural units derived from ethylene, (meth)acrylate, and glycidyl (meth)acrylate. Advantageously component C is a terpolymer selected from the group consisting of ethylene/ alkylacrylate/glycidyl methacrylate; ethylene/alkyl acrylate/glycidyl acrylate; ethylene/alkyl methacrylate/glycidyl acrylate; and ethylene/alkyl methacrylate/glycidyl methacrylate. The alkyl component of the (meth)acrylate desirably contains between 1 to 10 carbon atoms. Preferably, the alkyl acrylate or methacrylate polymer of the terpolymer is a methyl acrylate or methyl methacrylate.

The relative amounts of these units are 1 to 40%, preferably 5 to 35%, more preferably 25 to 33% of (meth)acrylate, 1 to 20%, preferably 4 to 20%, more preferably 7 to 10% of glycidyl(meth)acrylate, the balance in each case, preferably 55 to 80% being units derived from ethylene.

The preferred component (C) has a melting point of about 149° F. and Vicat softening point of <100° F., measured according to ASTM D₁₅₂₅ under a 1 kg load. The melt index, measured at 190° C. under a 2.16 kg load using ASTM Method D₁₂₃₈, is 6.5 gm/10 min. Advantageously the number average molecular weight of the suitable terpolymer is 10,000 to 70,000.

A terpolymer suitable as component (C) conforming to

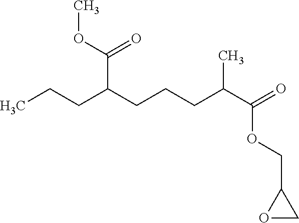 [SMILES: CCCC(CCCC(C)C(=O)OCC1CO1)C(=O)OC]

is available commercially from Arkema as Lotader AX8900.

Component C may be present in the thermoplastic composition in an amount of greater than 0 to 6 wt. %, preferably 1 to 4 wt. %, more preferably 2 to 3 wt. % of the thermoplastic composition.

### (D) Second Graft (Co)polymer

The second graft (co)polymer, component (D) of the inventive composition has core/shell structure. The second graft (co)polymer is preferably prepared by emulsion polymerization. It may be obtained by graft polymerizing alkyl(meth)acrylate and optionally a copolymerizable vinyl monomer onto a composite rubber core. In a preferred embodiment, component D is different from component B.

The composite rubber core that includes interpenetrated and inseparable interpenetrating network (IPN) type polymer is characterized in that its glass transition temperature (Tg) is below 10° C., preferably below −20° C., especially below −40° C. As used herein, the Tg of a copolymer is the Tg value as measured by differential scanning calorimetry (heating rate 20° C./minute, Tg value determined at inflection point). Suitable such graft (co)polymers are known and have been described in the literature including U.S. Pat. Nos. 6,362,269; 6,403,683; and 6,780,917, all incorporated herein by reference.

The amount of component D present in the inventive composition is 1 to 20, advantageously 2 to 15, preferably 5 to 12, most preferably 7 to 10 phr.

The core may be comprised of polysiloxane-alkyl(meth)acrylate interpenetrating network (IPN) type polymer that contains polysiloxane and butylacrylate. In another embodiment, the core comprises repeating units derived from a monoethylenically unsaturated acrylate monomer (acrylic core-shell copolymer). In a preferred embodiment, the core does not comprise polybutadiene.

The shell is a rigid phase, preferably comprising repeating units derived from a monoethylenically unsaturated monomer, such as polymerized methyl methacrylate, ethyl methacrylate, propyl methacrylate, isopropyl methacrylate and butyl methacrylate, styrene, acrylonitrile, and preferably methyl methacrylate, ethyl methacrylate, butyl methacrylate, or a mixture thereof. In a preferred embodiment, the monoethylenically unsaturated monomer is methylmethacrylate.

The shell portion may independently include a minor amount of repeating units derived from a polyethylenically unsaturated “crosslinking” monomer, e.g., butylene diacrylate or divinyl benzene, and a minor amount of repeating units derived from a polyethylenically unsaturated “graftlinking” monomer wherein the sites of ethylenic unsaturation have substantially different reactivities, e.g., allyl methacrylate or diallyl maleate.

The core and the shell portions may each independently further include repeating units derived from other monoethylenically unsaturated monomers such as vinyl aromatic monomers, e.g., styrene, alpha-methyl styrene, vinyl toluene, vinyl xylene, trimethyl styrene, chlorostyrene, dichlorostyrene bromostyrene and mixtures thereof, provided the respective limitations on Tg are satisfied.

The rubber core may have a median particle size (d5o value) of 0.05 to 5, preferably 0.1 to 2 microns, especially 0.1 to 1 micron. The median value may be determined by ultracentrifuge measurement (W. Scholtan, H. Lange, Kolloid, Z. und Z. Polymere 250 (1972), 782-1796).

In a preferred embodiment, the core of the acrylic core-shell copolymer comprises repeating units derived from butyl acrylate and the shell of the acrylic core-shell copolymer comprises repeating units derived from methyl methacrylate and styrene. In another embodiment, the core comprises repeating units derived from butyl acrylate and the shell comprises repeating units derived from methyl methacrylate. In the acrylic core-shell copolymer the acrylate rubber core is crosslinked with suitable crosslinking monomers. Suitable crosslinking monomers include polyacrylic and polymethacrylic esters of polyols such as butylene diacrylate and dimethacrylate, trimethylol propane trimethacrylate and the like, di- and trivinyl benzene, vinyl acrylate and methacrylate, and the like. The preferred crosslinking monomer is butylene diacrylate.

Suitable acrylic core-shell copolymers are described for example in US 2015/0225576 A1 and U.S. Pat. No. 5,905,120.

In an embodiment wherein the core comprises polyorganosiloxane, the polyorganosiloxane component in the silicone acrylate composite rubber may be prepared by reacting an organosiloxane and a multifunctional crosslinker in an emulsion polymerization process. It is also possible to insert graft-active sites into the rubber by addition of suitable unsaturated organosiloxanes.

Silicone rubber components of the silicone-acrylate rubber core can preferably be prepared by emulsion polymerization, in which the siloxane monomer structural units, crosslinkers or branching agents and optionally grafting agents can be used.

There can be used as the siloxane monomer structural units, for example and preferably, dimethylsiloxane or cyclic organosiloxanes having at least 3 ring members, preferably from 3 to 6 ring members, such as, for example and preferably, hexamethylcyclotrisiloxane, octamethyl-cyclotetrasiloxane, decamethylcyclopentasiloxane, dodecamethyl-cyclohexasiloxane, trimethyl-triphenyl-cyclotrisiloxane, tetramethyl-tetraphenyl-cyclotetrasiloxane, octaphenylcyclotetrasiloxane.

The organosiloxane monomers can be used on their own and/or in the form of mixtures of 2 or more monomers. The silicone rubber preferably contains not less than 50 wt. % and particularly preferably not less than 60 wt. % organosiloxane, based on the total weight of the silicone rubber component.

As crosslinkers or branching agents there can be preferably used silane-based crosslinkers having a functionality of 3 or 4, particularly preferably 4. Preferred examples which may be mentioned include: trimethoxymethylsilane, triethoxyphenylsilane, tetramethoxysilane, tetraethoxysilane, tetra-n-propoxysilane and tetrabutoxysilane. The crosslinker can be used on its own and/or in a mixture of two or more. Tetraethoxysilane is particularly preferred in some cases.

A crosslinker can be used, for example, in an amount in the range from 0.1 to 40 wt. %, based on the total weight of the silicone rubber component. The amount of crosslinker is preferably so chosen that the degree of swelling of the silicone rubber, measured in toluene, is from 3 to 30, preferably from 3 to 25 and particularly preferably from 3 to 15. The degree of swelling is defined as the weight ratio of the amount of toluene absorbed by the silicone rubber when it is saturated with toluene at 25° C. and the amount of silicone rubber in the dry state. The determination of the degree of swelling is described in detail in EP 249964, which is incorporated herein by reference.

Tetrafunctional branching agents are often preferred to trifunctional branching agents because the degree of swelling can then more easily be controlled within the above-described limits.

Suitable grafting agents are compounds that are capable of forming structures of the following formulae:

CH₂=C(R²)—COO—(CH₂)ₚ−SiR¹ ₙO_{(3-n)/2} (V-1)

CH₂=CH-SiR¹ₙO_{(3-n/2} (V-2) or

HS—(CH₂)ₚ—SiR¹ₙO_{(3-n)/2} (V3)

wherein
R¹ represents C₁-C₄-alkyl, preferably methyl, ethyl or propyl, or phenyl,
R² represents hydrogen or methyl,
n denotes 0, 1 or 2 and
p denotes an integer from 1 to 6.

Acryloyl- or methacryloyl-oxysilanes are particularly suitable for forming the above-mentioned structure (V-1) and have a high grafting efficiency. Effective formation of the graft chains is thereby often ensured, and the impact strength of the resulting resin composition is accordingly typically promoted. Preferred examples which may be mentioned include: β-methacryloyloxy-ethyldimethoxymethyl-silane, γ-methacryloyloxy-propyl-methoxydimethyl-silane, γ-methacryloyloxy-propyldimethoxy-methyl-silane, γ-methacryloyloxy-propyltrimethoxy-silane, γ-methacryloyloxy-propylethoxy-diethyl-silane, γ-methacryloyloxy-propyldiethoxymethyl-silane, b-methacryloyl-oxy-butyldiethoxymethyl-silane or mixtures thereof.

Preferably from 0 to 20 wt. % of a suitable grafting agent, based on the total weight of the silicone rubber, is used.

The silicone rubber can be prepared by any method such as emulsion polymerization, as described, for example, in U.S. Pat. Nos. 2,891,920 and 3,294,725. The silicone rubber is thereby obtained in the form of an aqueous latex. To that end, a mixture containing organosiloxane, crosslinker and optionally grafting agent is mixed with water, with shearing, for example by means of a homogenizer, in the presence of an emulsifier based, in a preferred embodiment, on sulfonic acid, such as, for example, alkylbenzenesulfonic acid or alkylsulfonic acid, the mixture polymerizing completely to give the silicone rubber latex. An alkylbenzenesulfonic acid is particularly suitable because it acts not only as an emulsifier but also as a polymerization initiator. In this case, a combination of the sulfonic acid with a metal salt of an alkylbenzenesulfonic acid or with a metal salt of an alkylsulfonic acid is advantageous because the polymer is thereby stabilized during the subsequent graft polymerization.

After the polymerization, the reaction is ended by neutralizing the reaction mixture by adding an aqueous alkaline solution, for example by adding an aqueous sodium hydroxide, potassium hydroxide or sodium carbonate solution.

Suitable polyalkyl (meth)acrylate rubber components of the silicone-acrylate rubbers core can be prepared, for example, from methacrylic acid alkyl esters and/or acrylic acid alkyl esters, a crosslinker and a grafting agent. Examples of preferred methacrylic acid alkyl esters and/or acrylic acid alkyl esters include the Ci- to C₈-alkyl esters, for example methyl, ethyl, n-butyl, tert-butyl, n-propyl, n-hexyl, n-octyl, n-lauryl and 2-ethylhexyl esters; haloalkyl esters, preferably halo-Cl-Ca-alkyl esters, such as chloroethyl acrylate, and mixtures of these monomers. n-Butyl acrylate is particularly preferred.

Preferable rubber graft bases are ones without carbon-carbon double bonds, such as those present in -diene compounds, like ABS. Carbon-carbon double bonds are less stable than carbon-carbon single bonds, and can become unstable through exposure to sunlight. Thus, preferable graft bases do not contain carbon-carbon double bonds.

As crosslinkers for the polyalkyl (meth)acrylate rubber component of the silicone-acrylate rubber there can be used monomers having more than one polymerizable double bond. Preferred examples of crosslinking monomers include esters of unsaturated monocarboxylic acids having from 3 to 8 carbon atoms and unsaturated monohydric alcohols having from 3 to 12 carbon atoms, or saturated polyols having from 2 to 4 OH groups and from 2 to 20 carbon atoms, such as ethylene glycol dimethacrylate, propylene glycol dimethacrylate, 1,3-butylene glycol dimethacrylate and 1,4-butylene glycol dimethacrylate. The crosslinkers can be used on their own or in mixtures of at least two crosslinkers.

Examples of preferred grafting agents include allyl methacrylate, triallyl cyanurate, triallyl isocyanurate or mixtures thereof. Allyl methacrylate can also be used as crosslinker. The grafting agents can be used on their own and/or in mixtures of at least two grafting agents.

The amount of crosslinker and grafting agent is advantageously from 0.1 to 20 wt. %, based on the total weight of the polyalkyl (meth)acrylate rubber component of the silicone-acrylate rubber.

The silicone-acrylate rubber can be prepared, for example, by first preparing the silicone rubber in the form of an aqueous latex. The latex is then enriched with the methacrylic acid alkyl esters and/or acrylic acid alkyl esters that are to be used, the crosslinker and the grafting agent, and a polymerization is carried out. Preference is given to an emulsion polymerization initiated by radicals, for example by a peroxide, an azo or a redox initiator. Particular preference is given to the use of a redox initiator system, especially of a sulfoxylate initiator system prepared by combination of iron sulfate, disodium ethylenediaminetetraacetate, rongalite and hydroperoxide.

The grafting agent that is used in the preparation of the silicone rubber preferably has the effect of bonding the polyalkyl (meth)acrylate rubber component covalently to the silicone rubber component. In the polymerization, the two rubber components interpenetrate and thus form the composite rubber, which can no longer be separated into its constituents of silicone rubber component and polyalkyl (meth)acrylate rubber component after the polymerization.

For the preparation of the silicone-acrylate graft polymers mentioned as component D, the monomers can be grafted on to the rubber base.

The polymerization methods described, for example, in EP 249964, EP 430134 and U.S. Pat. No. 4,888,388 can be used thereby.

For example, the graft polymerization can advantageously be carried out according to the following polymerization method: In a single- or multi-stage emulsion polymerization initiated by radicals, the desired vinyl monomers are polymerized on to the graft base, which is present in the form of an aqueous latex. The grafting efficiency should thereby be as high as possible and is preferably greater than or equal to 10%. The grafting efficiency is significantly dependent on the grafting agent or that is used. After the polymerization to the silicone (acrylate) graft rubber, the aqueous latex is added to hot water, in which metal salts, such as, for example, calcium chloride or magnesium sulfate, have previously been dissolved. The silicone (acrylate) graft rubber thereby coagulates and can subsequently be separated.

In an embodiment where Component D comprises core-shell morphology, Component D comprises about 60 to about 95 wt. % core, preferably 70 to about 90 wt. % core, with the remaining amount in Component D being the shell. The glass transition temperature of Component D is preferably −40° C. or less, most preferably −50° C. or less.

Component D may be, but is not limited to, impact modifiers having a core-shell morphology as disclosed above. Preferably, Component D does not comprise a functional shell polymer.

Particularly suitable graft (co)polymer is available from Mitsubishi Rayon Co., Ltd., Tokyo, Japan, under the Metablen trademark, or from The Dow Chemical Company, Midland, Mich., under the Paraloid trademark.

Component D may be present in the thermoplastic composition in an amount of greater than 0 to 15 wt. %, preferably 1 to 12 wt. %, more preferably 2 to 6 wt. % of the thermoplastic composition. In an embodiment, the ratio of the wt. of Component D to the wt. of Component C in the thermoplastic composition, ranges from 1.5:1 to 3:1, preferably from 1.7:1 to 2.4:1.

### (E) Reaction Catalyst

Finally, the thermoplastic composition includes component E, a reaction catalyst. The reaction catalyst is an alkylbenzene sulfonic acid, preferably a linear alkylbenzene sulfonic acid. The linear alkylbenzene sulfonic acid is preferably created from a long chain monoalkene, e.g. C₆-C₂₀, to produce a linear alkylbenzene sulfonic acid having 6 to 20 carbons in the alkyl chain. The linear alkylbenzene sulfonic acid is preferably selected from the group consisting of octylbenzene sulfonic acid, nonylbenzene sulfonic acid, decylbenzene sulfonic acid, undecylbenzene sulfonic acid and dodecylbenzene sulfonic acid, most preferably selected from the group consisting of octylbenzene sulfonic acid, decylbenzene sulfonic acid and dodecylbenzene sulfonic acid. In one embodiment, the linear alkylbenzene sulfonic acid is octylbenzene sulfonic acid. In another embodiment, the linear alkylbenzene sulfonic acid is decylbenzene sulfonic acid. In another preferred embodiment, the linear alkylbenzene sulfonic acid is dodecylbenzene sulfonic acid.

Component E is preferably present in the thermoplastic composition in an amount of 1000 ppm to 15000 ppm (0.1-1.5 wt. %), most preferably 3000 ppm to 11000 ppm (0.3 -1.1 wt. %), based on weight.

### (F) Third Graft (Co)polymer

Optionally, the thermoplastic composition may include component E, a vinyl (co)polymer. Suitable as the vinyl (co)polymers include polymers of at least one monomer selected from the group of the vinyl aromatic compounds, vinyl cyanides (unsaturated nitriles), (meth)acrylic acid (C₁-C₅)-alkyl esters, unsaturated carboxylic acids as well as derivatives (such as anhydrides and imides) of unsaturated carboxylic acids. Particularly suitable are (co)polymers of:

F.1 from 50 to 99 parts by weight, preferably from 60 to 80 parts by weight, in particular from 72 to 78 parts by weight (based on component F) of vinyl aromatic compounds and/or vinyl aromatic compounds substituted on the ring, such as styrene, α-methylstyrene, p-methylstyrene, p-chlorostyrene, and/or (meth)acrylic acid (C₁-C₅)-alkyl esters, such as methyl methacrylate, ethyl methacrylate, and
F.2 from 1 to 50 parts by weight, preferably from 20 to 40 parts by weight, in particular from 22 to 28 parts by weight (based on component F) of vinyl cyanides (unsaturated nitriles), such as acrylonitrile and methacrylonitrile, and/or (meth)acrylic acid (C₁-C₅)-alkyl esters, such as methyl methacrylate, n-butyl acrylate, tert-butyl acrylate, and/or unsaturated carboxylic acids, such as maleic acid, and/or derivatives, such as anhydrides and imides, of unsaturated carboxylic acids, for example maleic anhydride and N-phenylmaleimide.

The vinyl (co)polymers F are generally resin-like, thermoplastic and rubber-free. A preferred vinyl copolymer F is also a copolymer of F.1 styrene and F.2 acrylonitrile.

The (co)polymers according to F are known and can be prepared, for example, by radical polymerization, in particular by emulsion, suspension, solution or mass polymerization. The (co)polymers preferably have mean molecular weights M_{w} of from 15,000 to 200,000.

Factors in choosing component F for use with the thermoplastic composition is (1) improvement in flow performance of the resulting thermoplastic composition, and (2) its miscibility, and its compatibility with the other components of the thermoplastic composition.

Component F may be present in the thermoplastic composition in an amount of 0 to 15 wt. %, preferably greater than 0 to about 8 wt. % of the thermoplastic composition.

The inventive composition may further include additives that are known for their function in the context of thermoplastic compositions that contain poly(ester)carbonates. These include any one or more of lubricants, mold release agents, for example pentaerythritol tetrastearate, nucleating agents, antistatic agents, thermal stabilizers, light stabilizers, hydrolytic stabilizers, fillers and reinforcing agents, colorants or pigments, flame retarding agents and drip suppressants.

All percentages listed herein are wt. %, based on the total weight of the thermoplastic composition, unless otherwise indicated.

The inventive composition may be used to produce moldings of any kind by thermoplastic processes such as injection molding, extrusion and blow molding methods.

The Examples which follow illustrate the invention.

### Examples

In preparing the exemplified compositions that are described below the following materials were used:

Polycarbonate - a linear polycarbonate based on bisphenol A having a weight-average molecular weight MW of 25,000 g/mol (determined by GPC using polystyrene standards and tetrahydrofuran as solvent), conforming to Component A as described herein.
mass ABS - a mixture of 80% of component B-1, and 20% of component B-2.
Component B-1: Acrylonitrile(A)-butadiene(B)-styrene(S)-n-butyl acrylate(BA) polymer prepared by the bulk polymerization method, containing a disperse phase composed of rubber particles that have been grafted with styrene-acrylonitrile-n-butyl acrylate copolymer and are based on pure polybutadiene rubber as graft base, containing inclusions of styrene-acrylonitrile-n-butyl acrylate copolymer and a styrene-acrylonitrile-n-butyl acrylate copolymer matrix not bonded to the rubber. Component B-1 has an A:B:S:BA ratio of 22.5:10:63:4.5% by weight and a gel content, determined as the proportion insoluble in acetone, of 19% by weight. The tetrahydrofuran-soluble styrene-acrylonitrile-n-butyl acrylate copolymer in component B-1 is thus present in a proportion x(iv) of 81% by weight and has a weight-average molecular weight M_{w} (measured by GPC in tetrahydrofuran as solvent with polystyrene as standard) of 115 kg/mol. The median particle size of the disperse phase d5o, measured by ultracentrifugation, is 0.5 μm. The melt flow rate (MFR) of component B-1, measured to ISO 1133 (2012 version) at 220° C. with a ram load of 10 kg, is 28 g/10 min.
Component B-2: Acrylonitrile(A)-butadiene(B)-styrene(S) polymer prepared by the bulk polymerization method, containing a disperse phase composed of rubber particles that have been grafted with styrene-acrylonitrile copolymer and are based on pure polybutadiene rubber as graft base, containing inclusions of styrene-acrylonitrile copolymer and a styrene-acrylonitrile copolymer matrix not bonded to the rubber.
Component B-2 has an A:B:S ratio of 23:9:68% by weight and a gel content, determined as the proportion insoluble in acetone, of 20% by weight. The tetrahydrofuran-soluble styrene-acrylonitrile copolymer in component B-2 is thus present in a proportion x(ii) of 80% by weight and has a weight-average molecular weight M_{w} (measured by GPC in tetrahydrofuran as solvent with polystyrene as standard) of 160 kg/mol. The median particle size of the disperse phase d5o, measured by ultracentrifugation, is 0.9 μm. The melt flow rate (MFR) of component B-1, measured to ISO 1133 (2012 version) at 220° C. with a ram load of 10 kg, is 6.5 g/10 min.
emulsion ABS - a graft polymer with core-shell structure, prepared by emulsion polymerization of 43 wt. % of a mixture of 27% by weight of acrylonitrile and 73% by weight of styrene in the presence of 57% by weight based on the graft polymer of a particulate-crosslinked polybutadiene rubber (median particle diameter d5o=0.35 μm).
Linear glycidyl ester - a linear terpolymer which contains from 50 to 85 parts of units derived from ethylene, from 5 to 40 parts of units derived from a C₁ C₈ ester of (meth)acrylic acid, and from 2 to 10 parts of a copolymerizable monomer containing an epoxy group, methyl acrylate content 25%, GMA content 8%, conforming to Component C as described herein.
Second graft copolymer - the core of the acrylic core-shell copolymer comprises repeating units derived from butyl acrylate and the shell of the acrylic core-shell copolymer comprises repeating units derived from methyl methacrylate and styrene, conforming to Component D as described herein.
Reaction catalyst - dodecyl benzene sulfonic acid, conforming to Component E as described herein.
PC/emulsion ABS blend - blend of polycarbonate, styrene acrylonitrile and emulsion-based ABS (not Component B)
Polycarbonate/PBT blend - a blend of polycarbonate, polybutylene therephthalate, and a core-shell compound comprising butadiene, methyl methacrylate and styrene.
PC/emulsion ABS - blend of polycarbonate and emulsion-based ABS (not Component B).
Polycarbonate/Mass ABS blend - a blend of polycarbonate and mass polymerization ABS resin, conforming to a mixture of Components A and B as described herein.
Additives - a blend of thermal stabilizers, pigments, a UV stabilizer and a mold release agent.

The amounts listed below (in pbw unless otherwise indicated), combined with the amounts of various additives, add up to 100 pbw for each composition. Test specimens were conventionally molded from preparations of the compositions, which were then tested for chemical resistance. Tensile specimens were bent in a flexural fixture to fixed strains of 0.4% (low) and 1.2% (high). The stress corresponding to 1.0% strain is between 21 and 25 MPa, depending on the material. This greatly exceeds the molded-in and external stresses experienced by most parts, accelerating the time to crack and enabling a compatibility assessment within 24 hours.

First, each sample was exposed to Banana Boat sunscreen, available from Edgewell Personal Care Company, Shelton, Conn., at 23 degrees Celsius, for 24 hours. Either a wipe or a paper towel saturated with the liquid chemical was placed over the outer surface of each bent specimen. Each fixture was sealed in a zipper-lock plastic bag to minimize evaporation, ensuring 24-hour continuous exposure. Then, each sample was tested for elongation at various applied strain levels.

After chemical exposure, the specimens were carefully inspected visually for any cracks. Some cracks were tiny and only observed at the edges of specimens - these are still considered failures. Each specimen then underwent a tensile test according to ASTM D638, and its measured tensile strength was compared to unexposed controls.

The formulations, and the test results, are summarized below in Table 1a and Table 1b.

TABLE 1a

| | Comparative | Comparative | Comparative | Inventive |
|---|---|---|---|---|
| | Example 1 | Example 2 | Example 3 | Example 4 |
| Polycarbonate | 91.6 | 91.2 | 91.2 | 67.60 |
| mass ABS | 0.0 | 0.0 | 0.0 | 24 |
| linear glycidyl | 2.0 | 0.0 | 6.0 | 2 |
| ester | | | | |
| second graft | 4.0 | 6.0 | 0.0 | 4 |
| copolymer | | | | |
| reaction catalyst | 0.6 | 1.0 | 0 | 0.6 |
| additives | 1.8 | 1.8 | 1.8 | 1.8 |
| elongation @0% | 98.7 | 80.9 | 105.7 | 92.6 |
| applied strain (%) | | | | |
| elongation | 98.8 | 93.3 | 108.3 | — |
| @0.4% applied | | | | |
| strain (%) | | | | |
| elongation | 59.8 | 91.9 | 108.8 | 93.1 |
| @0.6% applied | | | | |
| strain (%) | | | | |
| elongation | 0.0 | 90.3 | 96.6 | 112.7 |
| @0.8% applied | | | | |
| strain (%) | | | | |
| elongation | 0.0 | 90.2 | 106.6 | 103.5 |
| @1.0% applied | | | | |
| strain (%) | | | | |
| elongation | 0.0 | 88.0 | 73.3 | 112.8 |
| @1.2% applied | | | | |
| strain (%) | | | | |

TABLE 1b

| | Inventive | Inventive | Inventive | Inventive |
|---|---|---|---|---|
| | Example 5 | Example 6 | Example 7 | Example 8 |
| polycarbonate | 71.60 | 74.6 | 78.2 | 81.2 |
| mass ABS | | | | |
| emulsion ABS | 20 | 17 | 14 | 11 |
| linear glycidyl | 2.0 | 2.0 | 2.0 | 2 |
| ester | | | | |
| second graft | 4.0 | 4.0 | 4.0 | 4 |
| copolymer | | | | |
| reaction catalyst | 0.6 | 0.6 | 0.6 | 0.6 |
| additives | 1.8 | 1.8 | 1.8 | 1.8 |
| elongation @0% | 93.4 | 94.6 | 91.3 | 92.0 |
| applied strain (%) | | | | |
| elongation | 92.6 | 92.3 | 88.6 | 93.3 |
| @0.4% applied | | | | |
| strain (%) | | | | |
| elongation | 94.3 | 93.4 | 94.2 | 85.9 |
| @0.6% applied | | | | |
| strain (%) | | | | |
| elongation | 94.7 | 93.9 | 95.2 | 94.3 |
| @0.8% applied | | | | |
| strain (%) | | | | |
| elongation | 95.0 | 92.8 | 93.8 | 94.7 |
| @1.0% applied | | | | |
| strain (%) | | | | |
| elongation | 94.3 | 92.8 | 92.1 | 94.7 |
| @1.2% applied | | | | |
| strain (%) | | | | |

As shown in Tables 1a and 1b above, the sample made from composition 4 was found to be the strongest, when tested for elongation at 1.2% applied strain, after being subjected to suntan lotion. This composition is nearly identical to the worst performing composition, number 1, except it includes a mixture of polycarbonate and ABS, rather than only polycarbonate. The samples made from compositions 5-8 also performed surprisingly well.

The compositions in Table 2 are described above. The composition of inventive example 4 is described in in Table 1 above, and the result were copied to be able to make a comparison. Each of the samples that were tested were prepared in the same manner as described above for Table 1, including exposure to Banana Boat sunscreen for 24 hours at 23 degrees Celsius.

TABLE 2

| | Comp. | | | |
|---|---|---|---|---|
| | Ex. 9 | Comp. | Comp. | Comp. |
| | PC/ | Ex. 10 | Ex. 11 | Ex. 12 |
| | emulsion | PC/ | PC/ | PC/ |
| | ABS | PBT | emulsion | mass |
| composition | blend | blend | ABS | ABS |
| elongation @0% | 100.8 | 135.0 | 92.6 | 103.0 |
| applied strain (%) | | | | |
| elongation | 50.0 | 59.5 | 96.2 | 103.6 |
| @0.4% applied | | | | |
| strain (%) | | | | |
| elongation | 0.0 | 52.6 | 100.5 | 101.8 |
| @0.6% applied | | | | |
| strain (%) | | | | |
| elongation | 0.0 | 7.5 | 101.1 | 55.6 |
| @0.8% applied | | | | |
| strain (%) | | | | |
| elongation | 0.0 | 3.4 | 0.0 | 0.0 |
| @1.0% applied | | | | |
| strain (%) | | | | |
| elongation | 0.0 | 2.3 | 0.0 | 0.0 |
| @1.2% applied | | | | |
| strain (%) | | | | |

The results in Table 2 demonstrate the advantage in having the linear glycydl ester, second graft copolymer and reaction catalyst in the composition. The samples made from the composition of Example 4 demonstrated a higher applied strain after being elongated at 1.2%, and also after extended contact with the suntan lotion.

In addition, the following aspects are disclosed:
1. A thermoplastic molding composition comprising: (A) 50 to 90 percent by weight relative to the weight of the composition (pbw) of an aromatic (co)poly(ester)carbonate, (B) greater than 0 to 40 pbw of first graft (co)polymer comprising structural units derived from styrene, acrylonitrile and 1,3-butadiene, (C) greater than 0 to 6 pbw of a linear glycidyl ester functional polymer comprising repeating units derived from one or more glycidyl ester monomers, (D) greater than 0 to 15 pbw of a second graft (co)polymer comprising a core and shell wherein the molecular structure of the core comprises (i) an interpenetrated network of poly(meth)alkyl acrylate and polyorganosiloxane or (ii) repeating units derived from a monoethylenically unsaturated acrylate monomer, and wherein the shell is a rigid phase comprising repeating units derived from a monoethylenically unsaturated monomer selected from the group consisting of methyl methacrylate, ethyl methacrylate, propyl methacrylate, isopropyl methacrylate and butyl methacrylate, styrene and acrylonitrile, and (E) 0.1-1.5 pbw of an alkylbenzene sulfonic acid.
2. The composition of 1 wherein the aromatic (co)poly(ester)carbonate is present in the composition in an amount of 58-72 pbw, preferably 62-68 pbw, most preferably 63-66 pbw.
3. The composition of 1 or 2 wherein Component B further comprises structural units derived from at least one alkyl (meth)acrylate.
4. The composition of any of the preceding wherein Component B comprises (i) a disperse phase comprising rubber particles and (ii) a rubber-free vinyl copolymer matrix not bound to the rubber particles and not incorporated into the rubber particles.
5. The composition of 4 wherein the disperse phase consists of (i1) rubber particles grafted with vinyl copolymer composed of structural units derived from styrene, acrylonitrile and optionally at least one alkyl (meth)acrylate; and (i.2) vinyl copolymer incorporated in the rubber particles as a separate disperse phase, likewise composed of structural units derived from styrene, acrylonitrile and optionally at least one alkyl (meth)acrylate.
6. The composition of 4 or 5 wherein the disperse phase (i) has a median diameter D₅₀ measured by ultracentrifugation of 0.3 to 2.0 μm, further preferably of 0.5 to 1.5 μm, especially of 0.7 to 1.2 μm.
7. The composition of any of the preceding wherein the first graft (co)polymer is a product of mass suspension polymerization.
8. The composition of any of the preceding wherein the first graft (co)polymer is free of alkali metal, alkaline earth metal, ammonium or phosphonium salts of saturated fatty acids having 8 to 22 carbon atoms, resin acids, alkyl- and alkylarylsulfonic acids and fatty alcohol sulfates.
9. The composition of any of the preceding wherein the first graft (co)polymer is free of at least one of all salts, all surfactants and all emulsifiers, preferably free of all salts, surfactants and emulsifiers.
10. The composition of any of the preceding wherein the first graft (co)polymer contains less than 100 ppm, preferably less than 50 ppm, more preferably less than 20 ppm, of ions of alkali metals and alkaline earth metals.
11. The composition of any of the preceding wherein the first grant (co)polymer is present in the composition in an amount of 5-35 pbw, preferably 10-30 pbw, most preferably 17-26 pbw.
12. The composition of any of the preceding wherein the linear glycidyl ester is a terpolymer selected from the group consisting of ethylene/ alkylacrylate/glycidyl methacrylate; ethylene/alkyl acrylate/glycidyl acrylate; ethylene/alkyl methacrylate/glycidyl acrylate; and ethylene/alkyl methacrylate/glycidyl methacrylate.
13. The composition of any of the preceding wherein the linear glycidyl ester functional polymer is present in the composition in an amount of 1-4 pbw, preferably 2-3 pbw.
14. The composition of any of the preceding wherein the molecular structure of the core of the second graft (co)polymer comprises an interpenetrated network of polybutyl acrylate and polysiloxane.
15. The composition of any of the preceding wherein the molecular structure of the core of the second graft (co)polymer comprises butyl acrylate.
16. The composition of any of the preceding wherein the core of the second graft (co)polymer does not comprise polybutadiene.
17. The composition of any of the preceding wherein the shell is a rigid phase comprising repeating units derived from methyl methacrylate.
18. The composition of 17 wherein the shell is a rigid phase comprising repeating units derived from methyl methacrylate and styrene.
19. The composition of any of the preceding wherein the component D is different from component B.
20. The composition of any of the preceding, wherein the second graft (co)polymer is present in the composition in an amount of from 1-12 pbw, preferably 2-6 pbw.

21. The composition of any of the preceding, wherein the ratio of the wt. of Component D to the wt. of Component C in the thermoplastic composition, ranges from 1.5:1 to 3:1, preferably from 1.7:1 to 2.4:1.
22. The composition of any of the preceding, wherein the alkylbenzene sulfonic acid comprises a C₆ - C₂₀ long chain monoalkene.
23. The composition of 22, wherein the alkylbenzene sulfonic acid is selected from the group consisting of octylbenzene sulfonic acid, nonylbenzene sulfonic acid, decylbenzene sulfonic acid, undecylbenzene sulfonic acid and dodecylbenzene sulfonic acid, preferably from the group consisting of octylbenzene sulfonic acid, decylbenzene sulfonic acid and dodecylbenzene sulfonic acid.
24. The composition of any of the preceding, wherein the alkylbenzene sulfonic acid is present in the composition in an amount of 0.3-1.1 pbw.
25. The composition of any of the preceding, further comprising (F) a vinyl (co)polymer comprising a vinyl compound selected from the group consisting of styrene, α-methylstyrene, p-methylstyrene, p-chlorostyrene, and (meth)acrylic acid (C₁-C₅)-alkyl esters.
26. The composition of 25, wherein the vinyl (co)polymer is styrene acrylonitrile.
27. The composition of 25 or 26, wherein the vinyl (co)polymer is present in the composition in an amount of greater than 0 to 15 pbw, preferably greater than 0 to 8 pbw.
28. The composition of any of the preceding further comprising at least one member selected from the group consisting of lubricant, mold release agents, nucleating agent, antistatic agent, thermal stabilizer, light stabilizer, hydrolytic stabilizer, filler, reinforcing agent, colorant, pigment, flame retarding agent and drip suppressant.

1: A thermoplastic molding composition comprising:
(A) 50 to 90, percent by weight relative to the weight of the composition (pbw) of an aromatic (co)poly(ester)carbonate,
(B) greater than 0 to 40, pbw of first graft (co)polymer comprising structural units derived from styrene, acrylonitrile, and 1,3-butadiene,
(C) greater than 0 to 6 , ester functional polymer comprising repeating units derived from one or more glycidyl ester monomers,
(D) greater than 0 to 15pbw of a second graft (co)polymer comprising a core and shell wherein the molecular structure of the core comprises (i) an interpenetrated network of poly(meth)alkyl acrylate and polyorganosiloxane or (ii) repeating units derived from a monoethylenically unsaturated acrylate monomer, and wherein the shell is a rigid phase comprising repeating units derived from a monoethylenically unsaturated monomer selected from the group consisting of methyl methacrylate, ethyl methacrylate, propyl methacrylate, isopropyl methacrylate and butyl methacrylate, styrene and acrylonitrile, and
(E) 0.1-1.5pbw of an alkylbenzene sulfonic acid.

2: The composition of claim 1 wherein Component B further comprises structural units derived from at least one alkyl (meth)acrylate.

3: The composition of claim 1 wherein Component B comprises (i) a disperse phase comprising rubber particles comprising (i.1) rubber particles grafted with vinyl copolymer composed of structural units derived from styrene, acrylonitrile and optionally at least one alkyl (meth)acrylate; and (i.2) vinyl copolymer incorporated in the rubber particles as a separate disperse phase, likewise composed of structural units derived from styrene, acrylonitrile and optionally at least one alkyl (meth)acrylate; and (ii) a rubber-free vinyl copolymer matrix not bound to the rubber particles and not incorporated into the rubber particles.

4: The composition of claim 1, wherein the disperse phase (i) has a median diameter D₅₀ measured by ultracentrifugation of 0.3 to 2.0 μm.

5: The composition claim 1, wherein the first graft (co)polymer is a product of mass suspension polymerization.

6: The composition of claim 1, wherein the first graft (co)polymer is free of alkali metal, alkaline earth metal, ammonium or phosphonium salts of saturated fatty acids having 8 to 22 carbon atoms, resin acids, alkyl- and alkylarylsulfonic acids and fatty alcohol sulfates.

7: The composition of claim 1, wherein the first graft (co)polymer is free of at least one of all salts, all surfactants and all emulsifiers.

8: The composition of a claim 1, wherein the first graft (co)polymer contains less than 100 ppm of ions of alkali metals and alkaline earth metals.

9: The composition of claim 1, wherein the linear glycidyl ester is a terpolymer selected from the group consisting of ethylene/alkylacrylate/glycidyl methacrylate, ethylene/alkyl acrylate/glycidyl acrylate; ethylene/alkyl methacrylate/glycidyl acrylate, and ethylene/alkyl methacrylate/glycidyl methacrylate.

10: The composition of claim 1, wherein the molecular structure of the core of the second graft (co)polymer comprises an interpenetrated network of polybutyl acrylate and polysiloxane.

11: The composition of claim 1, wherein the shell is a rigid phase comprising repeating units derived from methyl methacrylate and styrene.

12: The composition of claim 1, wherein the ratio of the wt. of Component D to the wt. of Component C in the thermoplastic composition, ranges from 1.5:1 to 3:1.

13: The composition of claim 1, wherein the alkylbenzene sulfonic acid comprises a C₆ - C₂₀ long chain monoalkene.

14: The composition of claim 13, wherein the alkylbenzene sulfonic acid is selected from the group consisting of octylbenzene sulfonic acid, nonylbenzene sulfonic acid.

15: The composition of claim 1, further comprising (F) a vinyl (co)polymer comprising a vinyl compound selected from the group consisting of styrene, α-methylstyrene, p-methylstyrene, p-chlorostyrene, and (meth)acrylic acid (C₁-C₈)-alkyl esters.
